(19) United States
(12) Patent Application Publication
(10) Pub. No.: US 2024/0005437 A1
(43) Pub. Date: Jan. 4, 2024

(54) INFORMATION PROCESSING APPARATUS AND INFORMATION PROCESSING SYSTEM

(71) Applicant: TOYOTA JIDOSHA KABUSHIKI KAISHA, Toyota-shi (JP)

(72) Inventors: Toshiki KASHIWAKURA, Nagakute-shi (JP); Takahiro AOKI, Nagoya-shi (JP); Tsuyoshi OKADA, Nagoya-shi (JP); Hiromitsu FUJII, Kariya-shi (JP)

(21) Appl. No.: 18/343,790

(22) Filed: Jun. 29, 2023

(30) Foreign Application Priority Data
Jul. 1, 2022 (JP) 2022-107326

(51) Int. Cl. G06Q 50/30

(52) U.S. Cl. CPC G06Q 50/30

(57) ABSTRACT

An information processing apparatus comprises a controller configured to execute: transmitting user information to one or more user apparatuses associated with one or more first users, the user information being information related to the one or more first users who intend to board a bus operated on demand from a first point set as a boarding and alighting point for the bus.

### CROSS REFERENCE TO THE RELATED APPLICATION

This application claims the benefit of Japanese Patent Application No. 2022-107326, filed on Jul. 1, 2022, which is hereby incorporated by reference herein in its entirety.

### BACKGROUND

### Technical Field

The present disclosure relates to an on-demand bus.

### Description of the Related Art

There is known an on-demand bus which is operated in response to a request from a user. The on-demand bus has no stop provided at a fixed location and allows a user to board or alight at an arbitrary point, on the basis of the request.

As for this, for example, a system which sets a boarding and alighting point at a point closest to a user in an area determined in advance is disclosed in Japanese Patent Laid-Open No. 2021-051431.

### SUMMARY

It is an object of the present disclosure to enhance convenience for users of an on-demand bus.

The present disclosure in its one aspect provides an information processing apparatus comprises a controller configured to execute: transmitting user information to one or more user apparatuses associated with one or more first users, the user information being information related to the one or more first users who intend to board a bus operated on demand from a first point set as a boarding and alighting point for the bus.

The present disclosure in its another aspect provides an information processing apparatus that is an information processing apparatus associated with a user who is to board a bus operated on demand, comprising a controller configured to execute: receiving, from a server apparatus that manages operation of the bus, user information that is information related to one or more first users who intend to board the bus from a first point set as a boarding and alighting point for the bus.

The present disclosure in its another aspect provides an information processing system comprising: a server apparatus configured to manage operation of a bus operated on demand; and a user apparatus associated with a user who is to board the bus, wherein the user apparatus transmits a boarding request for the bus to the server apparatus, and the server apparatus generates user information that is information related to one or more first users who intend to board the bus from a first point on the basis of the boarding request, and transmits the user information to the user apparatus associated with the one or more first users.

Other aspects include a program for causing a computer to execute a method to be executed by the above-described apparatus or a computer-readable storage medium non-transitorily storing the program.

According to the present disclosure, it is possible to enhance convenience for users of an on-demand bus.

### BRIEF DESCRIPTION OF THE DRAWINGS

FIG. 1 is a schematic diagram of a traffic system according to a first embodiment;

FIG. 2 is a diagram illustrating constituent elements of a user apparatus 100;

FIG. 3 is an example of a boarding request to be transmitted from the user apparatus 100;

FIG. 4 is a diagram illustrating constituent elements of a server apparatus 200;

FIG. 5 is an example of user data 202B;

FIG. 6 is an example of operation data 202C;

FIG. 7 is an example of boarding information to be generated by the server apparatus 200;

FIG. 8 is an example of a screen to be provided to the user apparatus 100;

FIG. 9 is a diagram illustrating constituent elements of a vehicle-mounted apparatus 300;

FIG. 10 is an example of vehicle data;

FIG. 11 is a sequence chart of a process of making a boarding reservation;

FIG. 12 is a sequence chart of a process of setting an arrived flag;

FIG. 13 is a sequence chart of a process of providing boarding information to the user apparatus 100;

FIG. 14 is an example of a screen to be provided to the user apparatus 100;

FIG. 15 is a schematic diagram of a traffic system according to a second embodiment;

FIG. 16 is an example of a screen to be provided to a user apparatus 100 in the second embodiment;

FIG. 17 is a sequence chart of a process of changing a bus stop position; and

FIG. 18 is an example of a screen to be provided by a vehicle-mounted apparatus 300.

### DESCRIPTION OF THE EMBODIMENTS

There is known an on-demand bus which is operated on the basis of a request from a user. In such a system, a stop may not be placed at a fixed location, and a boarding and alighting point may be dynamically set on the basis of requests from a plurality of users.

However, when a user waits for a bus at a location with no equipment for waiting for buses, what kind of attributes people who come together have is unknown, which may make the user anxious. For example, it is difficult to find out whether people gathered on a road are bus users or have any other purposes.

An information processing apparatus according to the present disclosure solves the problem.

An information processing apparatus according to a first aspect of the present disclosure includes a controller configured to execute transmitting user information to one or more user apparatuses associated with one or more first users, the user information being information related to the one or more first users who intend to board a bus operated on demand from a first point set as a boarding and alighting point for the bus.

The information processing apparatus according to the first aspect is typically a server apparatus which manages operation of an on-demand bus.

The on-demand bus is a share-ride automobile which is operated in response to a request from a user. In the present embodiment, a boarding and alighting point for the on-demand bus is not determined in advance and is dynamically set in response to a request.

The information processing apparatus acquires the user information that is information related to one or more users (referred to as the first users) that intend to board the bus from the dynamically set first point and transmits the user information to the one or more user apparatuses associated with the first users.

With the above-described configuration, the plurality of users who are to board the bus from the first point each can acquire information on what kind of people other than the user are to board the same bus.

Note that the boarding and alighting point for the on-demand bus will be referred to as a “bus stop” in the following description. In the present embodiment, the bus stop is virtually placed, and a position of the bus stop is dynamically determined by a system.

The user information may include at least gender- or age group-related information of each of the first users. The user information may include at least information indicating whether each of the first users has arrived at the first point.

With the above-described configuration, it is possible to notify a user, for example, what kind of attributes people having boarding reservations have and how many ones of the people have arrived at a bus stop.

For this reason, the controller may acquire position information from each user apparatus and manage the position information.

Note that “the user information that is the information related to the one or more first users” may be information on all of the users (the first users) that are to board the bus from the target point or may include only information on some of the users.

The controller may change the boarding and alighting point for the bus on the basis of a change request transmitted from a user apparatus. For example, there may be a case where a bus stop is set at a point not suitable for the boarding and alighting point (for safety and other reasons).

In this case, the boarding and alighting point may be changed from the first point to a second point on the basis of a report from a user. For example, the second spot can be set at a point within a predetermined distance from the first point. Alternatively, the second point may be set in the vicinity of a predetermined facility (e.g., a shop). With this configuration, a bus stop can be reset close to a populous location.

If the boarding and alighting point is reset, notification to that effect may be given to each user apparatus and a terminal mounted on the bus. This allows both the users and the bus to share the fact that the boarding and alighting point has been reset.

An information processing apparatus according to a second aspect of the present disclosure is an information processing apparatus associated with a user who is to board a bus operated on demand, including a controller configured to execute receiving, from a server apparatus that manages operation of the bus, user information that is information related to one or more first users who intend to board the bus from a first point set as a boarding and alighting point for the bus.

The information processing apparatus according to the second aspect is a user apparatus which is capable of communication with the information processing apparatus (a server apparatus) according to the first aspect.

Specific embodiments of the present disclosure will be described below with reference to the drawings. A hardware configuration, a module configuration, a functional configuration, and the like described in each embodiment are not intended to limit the technical scope of the disclosure thereto unless otherwise described.

### First Embodiment

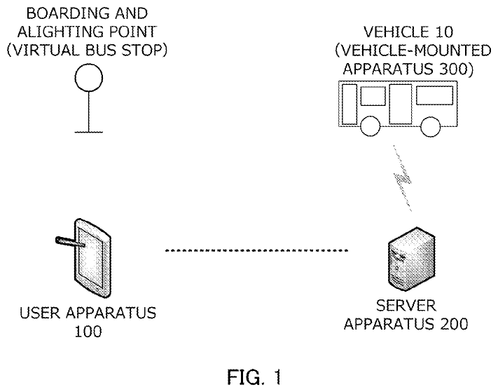

An outline of a traffic system according to a first embodiment will be described with reference to FIG. 1. The traffic system according to the present embodiment is configured to include a vehicle 10 equipped with a vehicle-mounted apparatus 300, a user apparatus 100, and a server apparatus 200. The number of vehicles 10 (vehicle-mounted apparatuses 300) included in the system may be two or more.

The vehicle 10 is an on-demand bus equipped with the vehicle-mounted apparatus 300. The on-demand bus is a share-ride automobile which is operated in response to a boarding request from a user. The vehicle 10 may be a vehicle driven by a busman or an autonomous vehicle. The vehicle-mounted apparatus 300 is configured to be capable of wireless communication with the server apparatus 200.

The vehicle 10 will be referred to as an on-demand bus or simply referred to as a bus below.

A user which desires to board the on-demand bus transmits a boarding request to the server apparatus 200 via the user apparatus 100. The boarding request includes, for example, a desired boarding point, a desired boarding time, a desired alighting point, and the like.

The above-described pieces of information can be generated and transmitted by, for example, application software for utilization of the traffic system which is installed on the user apparatus 100. Note that the pieces of information need not be generated using a mobile terminal. For example, the pieces of information may be generated using an arbitrary networkable terminal (e.g., a smartphone, a cellular phone, a tablet terminal, a personal information terminal, or a wearable computer) or a personal computer.

The server apparatus 200 generates a bus operation plan on the basis of the boarding request transmitted from the user apparatus 100. The operation plan includes, for example, an operation path for the on-demand bus, points where the user is allowed to board and alight, times of the boarding and the alighting, and the like.

The points where the user is allowed to board and alight can be determined by the server apparatus 200. For example, the server apparatus 200 determines a point where a user is allowed to board or alight on the basis of points where the user desires to board and alight and a road on which the bus can run. If a plurality of users desire to board from a plurality of points adjacent to each other and desire to move in a same direction, the server apparatus 200 may group the plurality of users and allow the plurality of users to board from a single point.

The server apparatus 200 creates a path which runs through points where users are to board and alight (and a schedule therefor), generates the operation plan described earlier, and transmits the operation plan to a target vehicle (the vehicle-mounted apparatus 300).

The vehicle-mounted apparatus 300 receives the operation plan from the server apparatus 200. If the bus is a manned vehicle, the operation plan is provided to a busman. If the bus is an unmanned vehicle, the operation plan is transmitted to an apparatus which is mounted on the bus and controls autonomous running.

In the traffic system according to the present embodiment, a plurality of user apparatuses 100, the server apparatus 200, and the vehicle-mounted apparatus 300 are connected to each other by a network. As the network, for example, a WAN (Wide Area Network) which is a worldwide public telecommunication network, such as the Internet, or any other communication network may be adopted. The network may include a telephone communication network for, e.g., a cellular phone, a wireless communication network, such as Wi-Fi(R).

Elements constituting the system will be described.

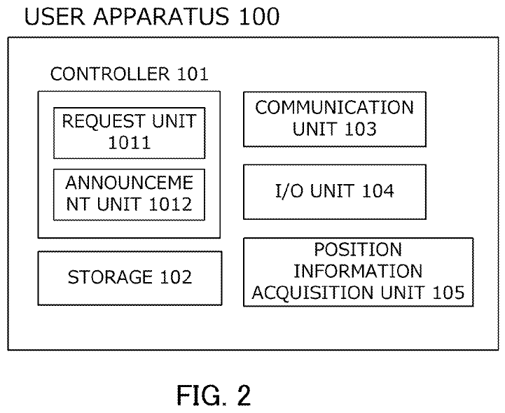

FIG. 2 is a diagram illustrating a system configuration of the user apparatus 100.

The user apparatus 100 is a small-sized computer, such as a smartphone, a cellular phone, a tablet computer, a personal information terminal, a notebook computer, or a wearable computer (e.g., a smartwatch). The user apparatus 100 is configured to include a controller 101, a storage 102, a communication unit 103, an I/O unit 104, and a position information acquisition unit 105.

The controller 101 is an arithmetic device responsible for control to be performed by the user apparatus 100. The controller 101 can be implemented by an arithmetic processing unit, such as a CPU (Central Processing Unit).

The controller 101 is configured to include two types of functional modules, a request unit 1011 and an announcement unit 1012. Each functional module may be implemented by executing a program stored in the storage 102, which is to be described later, by a CPU.

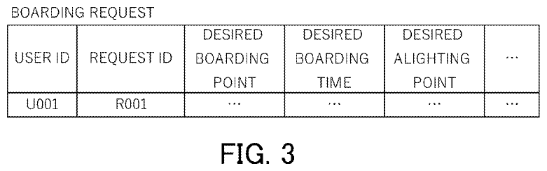

The request unit 1011 acquires, from a user of the apparatus, information necessary to make a boarding reservation for the on-demand bus and transmits a boarding request to the server apparatus 200. Specifically, the request unit 1011 acquires an identifier of the user, a desired boarding point, a desired boarding time, a desired alighting point, and the like via the I/O unit 104 (to be described later). The acquired pieces of information are transmitted as the boarding request to the server apparatus 200. FIG. 3 is an example of a boarding request generated by the request unit 1011. The request unit 1011 performs a process of confirming the boarding request by dialoging with the server apparatus 200.

The announcement unit 1012 acquires boarding-related information (hereinafter referred to as boarding information) from the server apparatus 200 after the boarding reservation is confirmed and provides the boarding information to the user. The boarding information is information for announcing a boarding point determined by the server apparatus 200, an arrival time for the bus, and the like to the user. The boarding information further includes information related to a plurality of users which are to board the same bus from a same bus stop. The information will be described later.

The storage 102 is configured to include a main memory and an auxiliary memory. The main memory is a memory into which a program to be executed by the controller 101 and data to be used by the control program are loaded. The auxiliary memory is a device in which the program to be executed in the controller 101 and the data to be used by the control program are stored. The program to be executed by the controller 101, packaged as an application, may be stored in the auxiliary memory. An operating system for execution of the application may be stored. The program stored in the auxiliary memory is loaded into the main memory and is executed by the controller 101, thereby performing processes to be described below.

The main memory may include a RAM (Random Access Memory) or a ROM (Read Only Memory). The auxiliary memory may include an EPROM (Erasable Programmable ROM) or a hard disk drive (HDD). The auxiliary memory may further include a removable medium, i.e., a removable recording medium. The removable medium is, for example, a USB (Universal Serial Bus) memory or a disc recording medium, such as a CD (Compact Disc) or a DVD (Digital Versatile Disc).

The communication unit 103 is a wireless communication interface for connection of the user apparatus 100 to the network. The communication unit 103 provides access to the network via, for example, a mobile communication service, such as a wireless LAN, 3G, or LTE.

The I/O unit 104 is a unit for accepting an input manipulation performed by a user of the apparatus and presenting information. In the present embodiment, the I/O unit 104 is composed of one touch panel display. That is, the I/O unit 104 is composed of a liquid crystal display and a control unit therefor and a touch panel and a control unit therefor.

A configuration of the server apparatus 200 will be described.

The server apparatus 200 can be constructed as a computer including a processor, such as a CPU or a GPU, a main memory, such as a RAM or a ROM, and an auxiliary memory, such as an EPROM, a hard disk drive, or a removable medium. An operating system (OS), various types of programs, various types of tables, and the like are stored in the auxiliary memory. Functions suiting a predetermined purpose, as will be described later, can be implemented by executing a program stored in the auxiliary memory. Note that some or all of the functions may be implemented by a hardware circuit, such as an ASIC or an FPGA. Note that the server apparatus 200 may be composed of a single computer or may be composed of a plurality of computers which collaborate with each other.

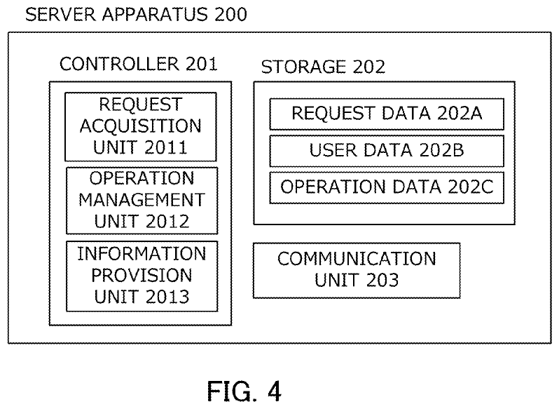

FIG. 4 is a diagram illustrating a system configuration of the server apparatus 200. The server apparatus 200 is configured to include a controller 201, a storage 202, and a communication unit 203.

The controller 201 is an arithmetic device responsible for control to be performed by the server apparatus 200. The controller 201 can be implemented by an arithmetic processing unit, such as a CPU.

The controller 201 is configured to include three types of functional modules, a request acquisition unit 2011, an operation management unit 2012, and an information provision unit 2013. Each functional module may be implemented by executing a program stored in the auxiliary storage by a CPU.

The request acquisition unit 2011 acquires a boarding request transmitted from the user apparatus 100 and temporarily stores the boarding request as request data 202A in the storage 202. The acquired and stored boarding request is used by the operation management unit 2012.

The operation management unit 2012 generates a bus operation plan on the basis of a plurality of boarding requests collected from a plurality of user apparatuses 100. The operation plan includes a bus operation path, an operation schedule, information on users which are allowed to board, and the like. The bus operation path and the operation schedule are generated on the basis of desires of the users included in the plurality of boarding requests.

The information provision unit 2013 provides boarding-related information (boarding information) to a user which intends to board the bus. Specifically, the information provision unit 2013 generates information announcing a boarding point, an arrival time, and the like on the basis of the generated operation plan in response to a request from the user apparatus 100 and provides the information to the user apparatus 100. Additionally, the information provision unit 2013 generates information related to a plurality of users which are to board the same bus from a same bus stop (also referred to as “fellow passengers”) and provides the information to the user apparatus 100.

The storage 202 is configured to include a main memory and an auxiliary memory. The main memory is a memory into which a program to be executed by the controller 201 and data to be used by the control program are loaded. The auxiliary memory is a device in which the program to be executed in the controller 201 and the data to be used by the control program are stored.

The request data 202A, user data 202B, and operation data 202C are stored in the storage 202.

The request data 202A is a collection of boarding requests received from a plurality of user apparatuses 100, as illustrated as an example in FIG. 3.

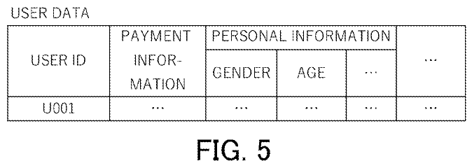

The user data 202B is data related to a plurality of users registered in the system. FIG. 5 is an example of the user data 202B. As illustrated in FIG. 5, an identifier (user ID) of each user, personal information, payment-related information, and the like are included in the user data 202B. Note that the personal information is information, disclosure of which to fellow passengers is permitted, such as gender and age (age group).

The operation data 202C is a collection of bus operation plans, each of which is generated on the basis of a plurality of boarding requests by the operation management unit 2012.

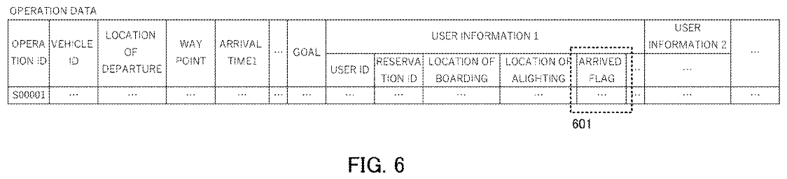

FIG. 6 is an example of the operation data 202C. As illustrated in FIG. 6, an identifier (operation ID) for unique identification of an operation, a vehicle identifier (vehicle ID), a point through which the bus passes, a time of the passage, information (user information) related to a user which is to board, and the like are included in the operation data 202C. An identifier of the user, an identifier of a boarding reservation, a boarding point, an alighting point, and the like are included in the user information. An arrived flag will be described later.

The communication unit 203 is a communication interface for connection of the server apparatus 200 to the network. The communication unit 203 is configured to include, for example, a network interface board and a wireless communication circuit for wireless communication.

A function to be provided by the information provision unit 2013 will now be described in more detail.

Upon a request from the user apparatus 100, the server apparatus 200 generates boarding information and transmits the boarding information to the user apparatus 100.

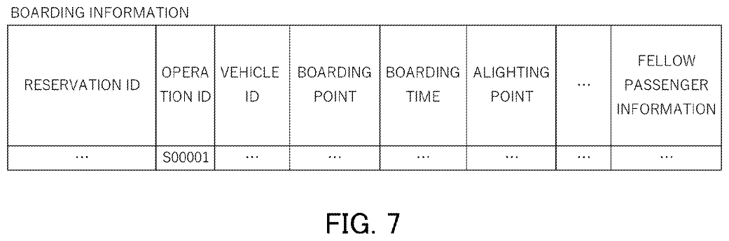

FIG. 7 is an example of boarding information to be provided to the user apparatus 100 by the information provision unit 2013. In the present example, a boarding point, a boarding time, and an alighting point are included in the boarding information. Information (fellow passenger information) related to a user which is to board the same bus from the same bus stop is also included in the boarding information. The number, ages, genders, and the like of users (fellow passengers) which are to board the same bus from the same bus stop are included in the fellow passenger information. Status information of a fellow passenger (e.g., information indicating whether the fellow passenger has arrived at the target bus stop) may be included in the fellow passenger information.

Note that the fellow passenger information may be information on all of the users who are to board the same bus from the same bus stop or information including only information on one or ones of the users (e.g., information except for information on a user which has requested the boarding information).

The boarding information can be generated on the basis of information obtained by searching the operation data 202C and the user data 202B.

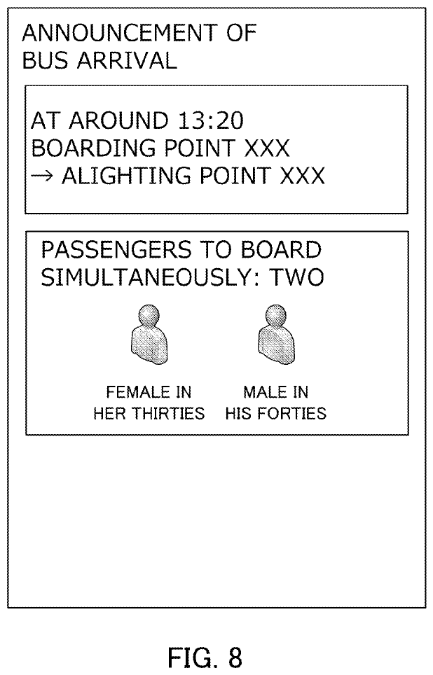

FIG. 8 is an example of a screen which is generated on the basis of the boarding information illustrated as an example in FIG. 7 by the user apparatus 100. Provision of such information to a user makes it possible to give a sense of reassurance to a user waiting for the bus.

A configuration of the vehicle-mounted apparatus 300 will be described.

The vehicle-mounted apparatus 300 is a computer mounted on the on-demand bus. The vehicle-mounted apparatus 300 exchanges operation-related information by communicating with the server apparatus 200.

The vehicle-mounted apparatus 300 may double as a device which provides information to a crew member or a passenger of the bus. For example, the vehicle-mounted apparatus 300 may be an instrument (hereinafter referred to as an operation-related instrument) which makes an announcement to passengers. Examples of the operation-related instrument include a destination indicator which the bus includes and an instrument which controls an announcement device.

The vehicle-mounted apparatus 300 may be an electronic control unit (ECU) which a vehicle platform includes. Alternatively, the vehicle-mounted apparatus 300 may be a data communication module (DCM) having a communication function.

The vehicle-mounted apparatus 300 has a function of communicating wirelessly with an external network. The vehicle-mounted apparatus 300 may have a function of downloading traffic information, road map data, and the like by communicating with the external network.

The vehicle-mounted apparatus 300 can be constructed as a computer including a processor, such as a CPU or a GPU, a main memory, such as a RAM or a ROM, and an auxiliary memory, such as an EPROM, a hard disk drive, or a removable medium. An operating system (OS), various types of programs, various types of tables, and the like are stored in the auxiliary memory. Functions suiting a predetermined purpose, as will be described later, can be implemented by executing a program stored in the auxiliary memory. Note that some or all of the functions may be implemented by a hardware circuit, such as an ASIC or an FPGA.

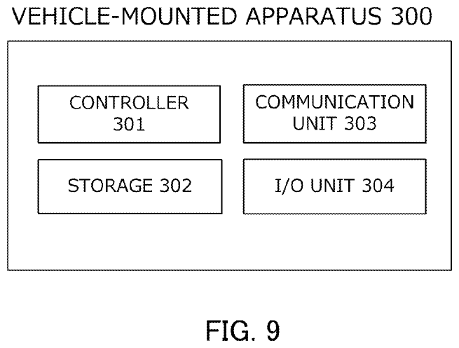

FIG. 9 is a diagram illustrating in detail constituent elements of the vehicle-mounted apparatus 300 which are mounted on the bus (the vehicle 10).

The vehicle-mounted apparatus 300 is configured to include a controller 301, a storage 302, a communication unit 303, and an I/O unit 304.

The controller 301 is an arithmetic unit which implements the various types of functions of the vehicle-mounted apparatus 300 by executing a predetermined program. The controller 301 may be implemented by, for example, a CPU. The controller 301 may implement the functions by executing a stored program by a CPU.

The controller 301 acquires or generates data related to bus operation and the vehicle (hereinafter referred to as vehicle data) at a predetermined timing and transmits the vehicle data to the server apparatus 200.

The vehicle data includes, for example, path information (an intended operation path), position information (a current running position), vehicle information, and the like.

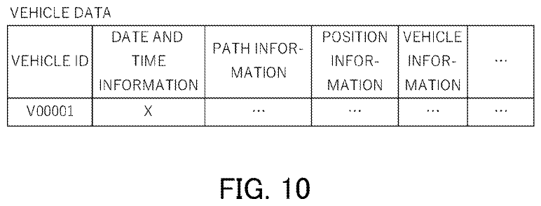

FIG. 10 is an example of the vehicle data. The vehicle data has respective fields for a vehicle ID, date and time information, path information, position information, and vehicle information. An identifier for unique identification of the vehicle is stored in the vehicle ID field. A date and time of generation of the vehicle data is stored in the date and time information field.

Information related to a bus operation path is stored in the path information field.

A section in which the bus is currently running is stored in the position information field. The position information may be represented by, for example, latitude and longitude or an identifier of a bus stop. The position information may be, for example, information that “the bus is running between the bus stops X1 and X2”.

The position information may be acquired via, for example, a GPS module which the bus (the vehicle 10) includes or acquired from the operation-related instrument described earlier. For example, a determination on the section, in which the bus is running, may be made on the basis of data acquired from the operation-related instrument.

Vehicle-related information of the on-demand bus is stored in the vehicle information field. The vehicle-related information may be, for example, information related to a bus type (e.g., a low-floor bus) and equipment (e.g., a space for a wheelchair or a slope for a wheelchair) which the bus includes.

The storage 302 is a unit for storing information and is composed of a storage medium, such as a RAM, a magnetic disk, or a flash memory. Various types of programs to be executed by the controller 301, data to be used by the programs, and the like are stored in the storage 302.

The communication unit 303 includes an antenna for wireless communication and a communication module. The antenna is an antenna element which inputs and outputs a wireless signal. In the present embodiment, the antenna is tailored to mobile communication (e.g., mobile communication, such as 3G, LTE, or 5G). Note that the antenna may be configured to include a plurality of physical antennas. For example, if mobile communication using radio waves in a high-frequency band, such as microwaves or milliwaves, is performed, a plurality of antennas may be dispersedly arranged to achieve communication stabilization. The communication module is a module for mobile communication.

The I/O unit 304 is a unit for accepting an input manipulation and presenting information. In the present embodiment, the I/O unit 304 is composed of one touch panel display. That is, the I/O unit 304 is composed of a liquid crystal display and a control unit therefor and a touch panel and a control unit therefor.

Note the configurations illustrated in FIGS. 2, 4, and 9 are examples and that all or some of the illustrated functions may be executed using a specifically designed circuit. Program storage or execution may be performed by a combination of a main memory and an auxiliary memory other than the illustrated ones.

Processes to be executed by the apparatuses will be described.

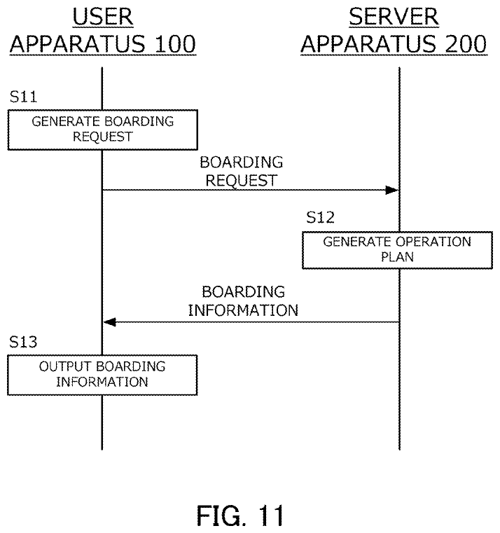

FIG. 11 is a sequence chart of a process of accepting a boarding reservation through interaction between the user apparatus 100 and the server apparatus 200. The illustrated process is started on the basis of a manipulation by a user.

First, in step S11, the user apparatus 100 (the request unit 1011) generates a boarding request. In the present step, the user apparatus 100 causes the user to input a desired boarding point, a desired alighting point, a desired boarding time, and the like via a predetermined interface. The request unit 1011 transmits the generated boarding request to the server apparatus 200 (the request acquisition unit 2011).

The boarding request acquired by the server apparatus 200 is accumulated until a predetermined trigger is pulled in the server apparatus 200. The trigger may be pulled periodically (e.g., every ten minutes) or may be pulled at a fixed time.

When the predetermined trigger is pulled, a process in step S12 is started.

In step S12, the operation management unit 2012 determines a point where users are to board or alight and a time of the boarding or alighting on the basis of a plurality of boarding requests in accordance with a predetermined rule and generates an operation plan including the point and the time. When the operation plan is generated, the operation management unit 2012 generates boarding information and transmits the boarding information to the user apparatus 100, and the request unit 1011 outputs the boarding information (step S13). The boarding information is information for making a boarding-related announcement and includes a boarding point, a boarding time, an alighting point, and fellow passenger-related information, as described with reference to FIG. 7. This allows the user to check that a boarding reservation completed.

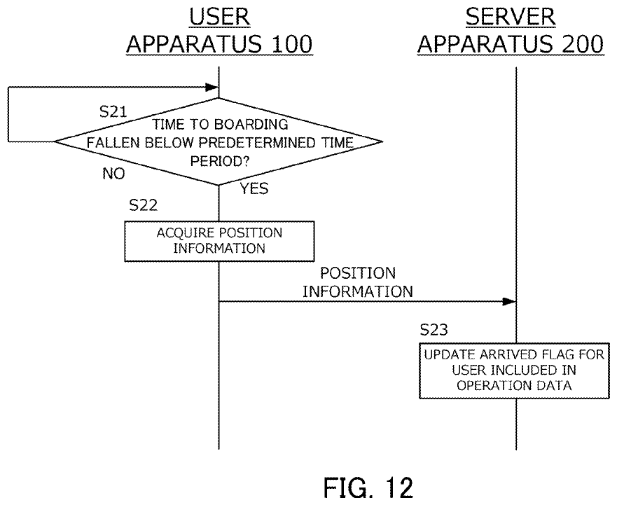

FIG. 12 is a sequence chart of a process of transmitting position information to the server apparatus 200 by the user apparatus 100.

In the present embodiment, when the time to arrival of the bus falls below a predetermined duration (e.g., 30 minutes), the user apparatus 100 starts periodical transmission of the position information to the server apparatus 200. The server apparatus 200 collects pieces of position information from a plurality of user apparatuses 100 and determines whether a corresponding user has arrived at a target bus stop.

In step S21, the announcement unit 1012 determines whether a time to boarding falls below a predetermined value. If the time to boarding falls below the predetermined value (e.g., 30 minutes), the process shifts to step S22, and the announcement unit 1012 acquires position information of the apparatus via the position information acquisition unit 105. The acquired position information is transmitted to the server apparatus 200.

In step S23, the server apparatus 200 (the information provision unit 2013) determines whether the corresponding user has arrived at the bus stop on the basis of the acquired position information. As indicated by reference numeral 601 in FIG. 6, the operation data 202C has, for each user, a flag (arrived flag) indicating whether the user has arrived at the bus stop. The information provision unit 2013 reflects a result of the determination in the corresponding arrived flag.

The server apparatus 200 can announce, to an arbitrary user, “whether a different user which is to board the same bus has arrived at the bus stop” by referring to the arrived flag.

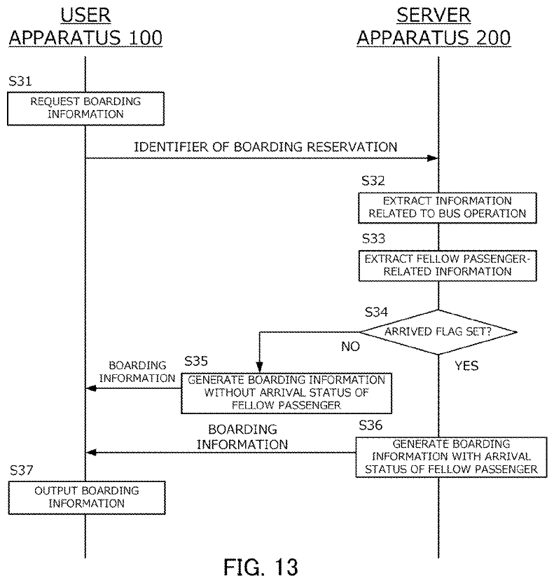

After a boarding reservation is completed, the user apparatus 100 can check boarding information at an arbitrary timing. FIG. 13 is a sequence chart of a process of providing boarding information by the server apparatus 200 in response to a request from the user apparatus 100.

In step S31, the announcement unit 1012 requests the server apparatus 200 to transmit boarding information. In the present step, an identifier (reservation ID) of a boarding reservation is transmitted from the user apparatus 100 to the server apparatus 200, and the server apparatus 200 (the information provision unit 2013) identifies the boarding reservation on the basis of the identifier and generates boarding information.

The server apparatus 200 acquires information (e.g., a boarding point and a boarding time) related to an operation of the bus which a target user intends to board in step S32. The information can be extracted by searching the operation data 202C using the reservation ID as a key.

In step S33, the server apparatus 200 acquires fellow passenger-related information. Information related to users (fellow passengers) which are to board the bus simultaneously with a given user can be extracted by searching the operation data 202C and the user data 202B. Here, information related to the number, genders, and age groups of the fellow passengers is extracted.

In step S34, it is determined whether an arrived flag is set for each of the fellow passengers. If the arrived flag is not set for the fellow passenger, the process shifts to step S35 to generate boarding information without an arrival status of the fellow passenger. If the arrived flag is set for the fellow passenger, the process shifts to step S36 to generate boarding information with the arrival status of the fellow passenger.

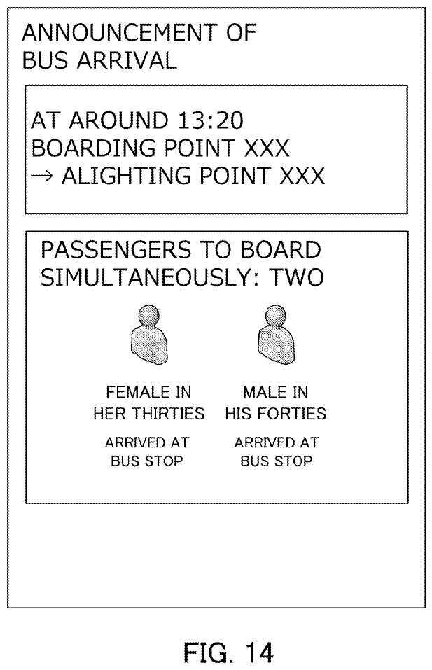

The generated boarding information is transmitted to the user apparatus 100 and is output in step S37. FIG. 8 is an example of a screen which is generated on the basis of boarding information without an arrival status of each fellow passenger, and FIG. 14 is an example of a screen which is generated on the basis of boarding information with the arrival status of each fellow passenger.

For this reason, a user which has made a reservation can recognize what kind of people are to board the bus simultaneously with the user. As illustrated as an example in FIG. 14, the user can recognize whether the people that are to board the bus simultaneously with the user have arrived at a bus stop.

As has been described above, in the traffic system according to the first embodiment, the server apparatus 200 manages information related to a user which is to board the bus from a dynamically set bus stop and provides the information to the user in response to a request from the user apparatus 100. With this configuration, a user which is to board the bus can recognize what kind of attributes people who are to board the bus together with the user have and whether each follow passenger has arrived at a bus stop. It is possible to recognize whether people close to the bus stop are users of the bus and ease anxiety at the time of waiting on a road.

### Second Embodiment

In the first embodiment, the server apparatus 200 determines a point where a user is to board or alight from a bus. However, it may be inappropriate to continue waiting for a bus at a designated point from the perspective of security and the like in some countries or districts.

A second embodiment is an embodiment which assumes the above-described case and in which a point where a user is to board or alight from a bus can be changed ex-post facto on the basis of a request from the user.

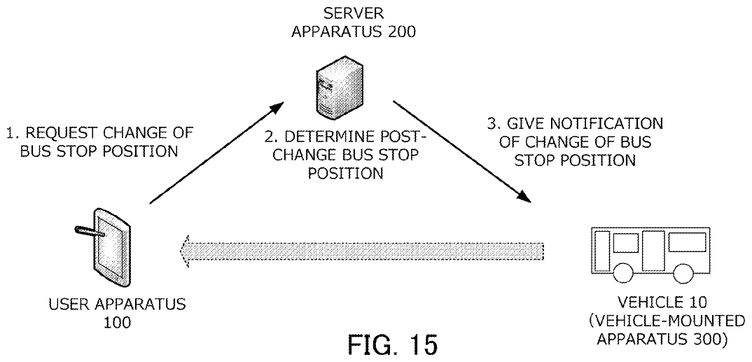

FIG. 15 is a diagram for explaining an outline of a traffic system according to the second embodiment.

In the second embodiment, after a reservation is confirmed, a user apparatus 100 can transmit a request (a change request) to change a bus stop position to a server apparatus 200. When the server apparatus 200 receives the change request, the server apparatus 200 changes the bus stop position in accordance with a predetermined procedure and transmits a post-change bus stop position to both the user apparatus 100 and a vehicle-mounted apparatus 300.

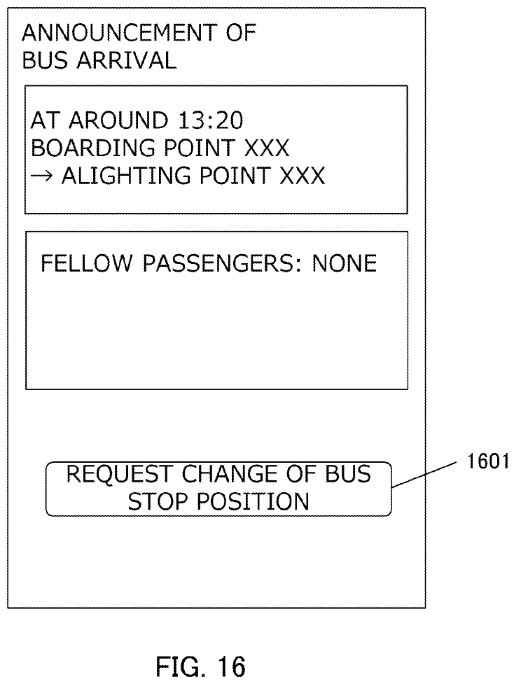

In the second embodiment, an announcement unit 1012 is configured to be capable of outputting a user interface for transmission of a change request. FIG. 16 is an example of a screen to be output by the announcement unit 1012. The screen becomes displayable when the time to an arrival time of a bus falls below a predetermined time period.

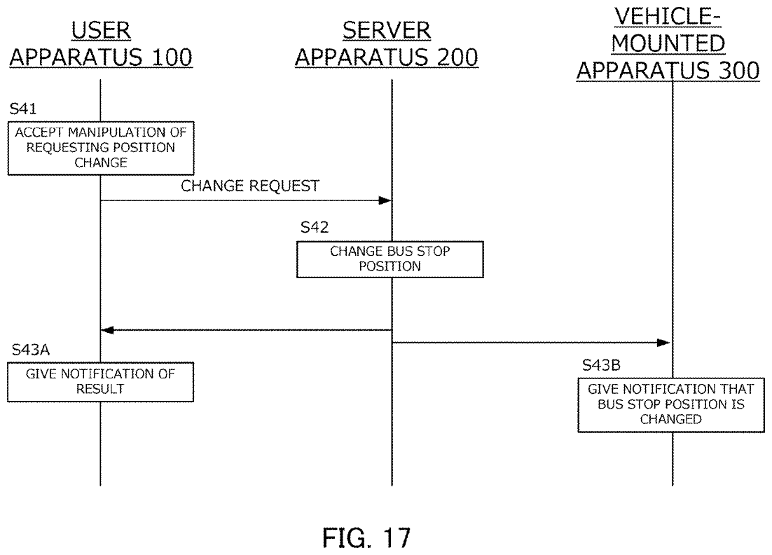

FIG. 17 is a sequence chart of a process of changing a bus stop position. The illustrated process is started when a user presses a button 1601 requesting change of the bus stop position.

When the user presses the button requesting change of the bus stop position (step S41), the request is transmitted to the server apparatus 200, and the operation management unit 2012 executes a process of changing the bus stop position (step S42).

The change of the bus stop position is performed by the following procedures.
(1) Specify a predetermined distance from a pre-change position as a center

The predetermined distance can be set at, for example, a distance which can be moved on foot.
(2) Select a facility within the predetermined distance

For example, a facility with greater safety than on a road, such a gathering facility, is extracted. If a plurality of facilities are extracted, one of the facilities may be selected on the basis of crowdedness and scale.
(3) Set a post-change bus stop close to the selected facility

A post-changed bus stop is set in the vicinity of the extracted facility (e.g., within 30 meters from a front entrance).

If the bus stop position is changed, data to that effect is transmitted from the server apparatus 200 to the user apparatus 100 (step S43A). Similar data is transmitted from the server apparatus 200 to the vehicle-mounted apparatus 300 (step S43B).

Note that although an example where the server apparatus 200 automatically selects a post-change bus stop position has been taken in the present embodiment, if there are a plurality of candidates, positions of the candidates may be transmitted to the user apparatus 100 to allow a user to select one.

A controller 301 which the vehicle-mounted apparatus 300 includes receives the notification transmitted from the server apparatus 200 and informs a busman of “the post-change bus stop position” via an I/O unit 304. The informing may be visually performed or performed by, e.g., voice. The I/O unit 304 is a unit which outputs information and includes, for example, a display device, a voice output device, and the like. If an operation-related instrument is mounted on a bus, the I/O unit 304 may collaborate with the instrument and output an image, a voice, or the like.

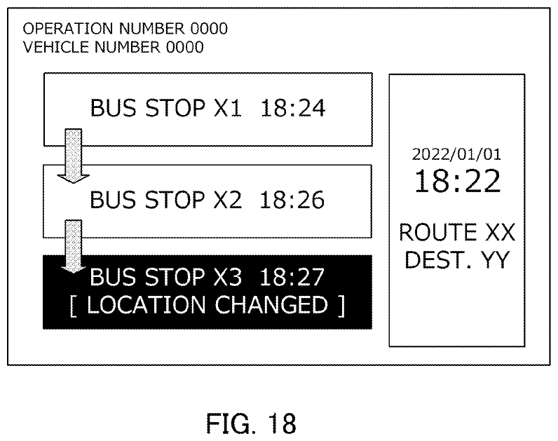

FIG. 18 is an example of a screen to be output by the operation-related instrument. The operation-related instrument is configured to include, for example, a monitor device which is installed in the vicinity of a driver seat. Operation-related information (e.g., a current time, bus stops through which the bus passes, and an intended arrival time) is generally output to the monitor device.

In the present example, a display to the effect that a bus stop position has been changed is output in a region corresponding to a bus stop (X3) where a target passenger intends to board. The controller 301 may output a detailed map indicating a post-change bus stop position. This allows the busman to recognize a point where the bus needs to be stopped.

Note that although an example where a bus stop position is changed by a request from a user has been taken in the present embodiment, the server apparatus 200 may voluntarily propose change of the bus stop position. For example, in a case where a predetermined condition is satisfied, such as “a case where there is no fellow passenger”, “a case where a low-traffic point is a boarding point”, or “a case where a boarding time is during the night”, the server apparatus 200 may propose change of the bus stop position at the time of making a boarding reservation.

Even in a case where the predetermined condition is not satisfied, if a facility with high anti-crime performance or the like is present in the neighborhood, a proposal to set a bus stop in the vicinity of the facility.

If there is another fellow passenger that is to board from the same bus stop, whether to perform change of a bus stop position may be determined on the basis of a result of interaction with a user apparatus held by the fellow passenger. Alternatively, the change of the bus stop position may be performed only if there is no fellow passenger that is to board from the same bus stop.

(Modifications)

The above-described embodiments are merely examples, and the present disclosure can be carried out by being appropriately changed without departing from the scope thereof.

For example, the processes and units described in the present disclosure can be freely combined and carried out as long as there is no technical contradiction.

Gender and age group have been illustrated as examples of fellow passenger-related information in the description of the embodiments. Any other information may be used as long as the information is information recognizable by appearance.

Processing described as being performed by one apparatus may be shared and executed by a plurality of apparatuses. Or alternatively, processing described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium connectable to a system bus of the computer or may be provided for the computer via a network. As the non-transitory computer-readable storage medium, for example, a disk of a given type such as a magnetic disk (a floppy (R) disk, a hard disk drive (HDD) and the like) and an optical disc (a CD-ROM, a DVD disc, a Blu-ray disc and the like), a read-only memory (ROM), a random-access memory (RAM), an EPROM, an EEPROM, a magnetic card, a flash memory, an optical card, and a medium of a given type that is appropriate for storing electronic commands are included.

What is claimed is:

1. An information processing apparatus comprising
a controller configured to execute:
transmitting user information to one or more user apparatuses associated with one or more first users, the user information being information related to the one or more first users who intend to board a bus operated on demand from a first point set as a boarding and alighting point for the bus.

2. The information processing apparatus according to claim 1, wherein
the user information includes at least gender-related information of each of the one or more first users.

3. The information processing apparatus according to claim 1, wherein
the user information includes at least information indicating whether each of the one or more first users is already at the first point.

4. The information processing apparatus according to claim 3, wherein
the controller acquires position information from the one or more user apparatuses and determines, on the basis of the position information, whether each of the one or more first users is already at the first point.

5. The information processing apparatus according to claim 1, wherein
the controller changes the boarding and alighting point for the bus from the first point to a second point within a predetermined distance from the first point on the basis of a change request transmitted from the user apparatus.

6. The information processing apparatus according to claim 5, wherein
the controller transmits information related to the second point to the user apparatus.

7. The information processing apparatus according to claim 5, wherein
the controller transmits information related to the second point to the user apparatus and a mobile terminal associated with the bus.

8. The information processing apparatus according to claim 5, wherein
the controller sets the second point in a vicinity of a predetermined facility.

9. The information processing apparatus according to claim 5, wherein
the controller proposes to set the second point in a vicinity of a predetermined facility if the predetermined facility is present in a vicinity of the first point.

10. An information processing apparatus that is an information processing apparatus associated with a user who is to board a bus operated on demand, comprising
a controller configured to execute:
receiving, from a server apparatus that manages operation of the bus, user information that is information related to one or more first users who intend to board the bus from a first point set as a boarding and alighting point for the bus.

11. The information processing apparatus according to claim 10, wherein
the controller transmits a boarding request including attribute information of the user to the server apparatus and acquires information related to the first point that is set on the basis of the boarding request and the user information from the server apparatus.

12. The information processing apparatus according to claim 11, wherein
the attribute information includes at least gender-related information, and
the user information includes gender-related information of each of the one or more first users.

13. The information processing apparatus according to claim 10, wherein
the controller transmits position information to the server apparatus and
receives, from the server apparatus, the user information including at least information indicating whether each of the one or more first users is already at the first point.

14. The information processing apparatus according to claim 13, wherein
whether each of the one or more first users is already at the first point is determined on the basis of a plurality of pieces of position information constituting the position information by the server apparatus.

15. The information processing apparatus according to claim 10, wherein
the controller transmits, to the server apparatus, a change request to change the boarding and alighting point for the bus from the first point to a second point within a predetermined distance from the first point on the basis of a request from the user.

16. The information processing apparatus according to claim 15, wherein
the controller receives, from the server apparatus, information related to the second point determined by the server apparatus.

17. An information processing system comprising:
a server apparatus configured to manage operation of a bus operated on demand; and
a user apparatus associated with a user who is to board the bus,
wherein the user apparatus
transmits a boarding request for the bus to the server apparatus, and
the server apparatus
generates user information that is information related to one or more first users who intend to board the bus from a first point on the basis of the boarding request, and
transmits the user information to the user apparatus associated with the one or more first users.

18. The information processing system according to claim 17, wherein
the boarding request includes attribute information of the user, and
the server apparatus generates the user information on the basis of the attribute information.

19. The information processing system according to claim 17, wherein
the user apparatus further transmits position information to the server apparatus, and
the server apparatus determines, on the basis of the position information received from one or more user apparatuses constituting the user apparatus, whether each of the one or more first users is already at the first point.

20. The information processing system according to claim 19, wherein
the server apparatus transmits the user information including at least information indicating whether each of the one or more first users is already at the first point to the one or more user apparatuses.
